(19) United States
(12) Patent Application Publication
(10) Pub. No.: US 2008/0103722 A1
(43) Pub. Date: May 1, 2008

(54) On-board temperature/humidity sensor

(76) Inventors: Scott Aldern, Encinitas, CA (US); Eric Stephen Mattis, San Diego, CA (US); Darrell L. Krulce, Carlsbad, CA (US)

Correspondence Address: QUALCOMM INCORPORATED, 5775 MOREHOUSE DR., SAN DIEGO, CA, 92121, US

(21) Appl. No.: 11/519,318

(22) Filed: Sep. 11, 2006

Related U.S. Application Data
(60) Provisional application No. 60/843,340, filed on Sep. 7, 2006.

(51) Int. Cl. G06F 15/00; G01K 13/00

(52) U.S. Cl. 702/130

(57) ABSTRACT

The specification and drawing figures describe and show an on-board temperature/humidity sensing device that includes an enclosure. The enclosure contains a circuit board. A sensor is mounted on the surface of the circuit board. The sensor is capable of monitoring environmental data within the enclosure. The sensor is operatively connected to a microprocessor with programmable sensor data acquisition capabilities capable of capable of establishing monitored threshold limits of environmental properties within the enclosure, monitoring, and transmitting environmental data to a remote data collector.

### CLAIM OF PRIORITY UNDER 35 U.S.C. §119

The present Application for Patent claims priority to Provisional Application No. ______ entitled “ON-BOARD TEMPERATURE/HUMIDITY SENSOR” filed Sep. 7, 2006, (attorney docket no. 061884P1) and assigned to the assignee hereof and hereby expressly incorporated by reference herein.

### BACKGROUND

The apparatus and method disclosed and claimed in this document pertains generally to sensors. More particularly, the new and useful on-board temperature/humidity sensor system disclosed and claimed in this document pertains to a sensor mounted in an enclosure on a vehicle used in conjunction with a mobile satellite communications system. The on-board temperature/humidity sensor is particularly, but not exclusively, useful for monitoring temperature and humidity within an enclosure on a vehicle that houses a satellite data modem, and is adapted to monitor structural integrity of the enclosure and functionality of the modem within the enclosure.

A system for at least two-way communications between one or more base stations such as a vehicle dispatcher, and a means of transport remote from the base station, is increasingly in demand. Users desire to track the location of vehicles, communicate with vehicle operators, and monitor various problems confronted by vehicle operators.

The term “means of transport” as used in this document includes but is not limited to not only ground-based motorized vehicles including trucks, cars, and trains, but also ships, boats, airborne means of transport, and the like (collectively in this document, “vehicle” or “vehicles”).

The term “remote” as used in this document means that one object is removed in space from another systemically interrelated but distant object or objects, or that one object has the capability of acting on, controlling, sending data to, or acquiring data from, such other systemically interrelated but distant object or objects, without coming into physical contact with one another.

Efforts to locate, track, identify, and communicate with such vehicles has been enhanced by combining the U.S. Global Positioning System with a variety of hardware and software system components.

Demand in the industry now also requires a new, useful and improved mobile satellite communications system with enhanced capabilities for inter-communication between at least one base station and one or more vehicles, such as Qualcomm Incorporated's OMNIVISION™ system (in this document, “mobile satellite communications system”). The on-board temperature/humidity sensor system disclosed and claimed in this document provides new and useful features for such a mobile satellite communications system by providing an apparatus and system for monitoring temperature and humidity within an enclosure that houses a satellite data modem mounted on a vehicle (in this document, an “enclosure”).

The on-board temperature/humidity sensor within the enclosure solves several problems associated with earlier modem enclosures. For example, data collected from monitoring at least temperature and humidity within an enclosure allows continuous and substantially real-time diagnoses of seals in the modem enclosure for stress, cracks or other failures, as well as the structural integrity of components assembled to make an enclosure. Sensor output may be polled and relayed to a remote data collector included as part of the remote monitoring capabilities of the mobile satellite communications system. On-going diagnoses are useful not only for addressing problems associated with an individual enclosure, but also for assessing the durability and integrity of components used to manufacture and assemble the enclosures collectively. These capabilities and features currently are not available to the industry.

### SUMMARY

The on-board temperature/humidity sensor system includes a sensor mounted on a circuit board within a vehicle-mounted enclosure that includes a microprocessor with programmable sensor data acquisition capabilities. The system is capable of establishing monitored threshold limits of environmental properties within the enclosure, and transmitting data concerning environmental properties within the enclosure to a remote data collector.

It will become apparent to one skilled in the art that the claimed subject matter as a whole, including the structure of the apparatus, and the cooperation of the elements of the apparatus, combine to result in a number of unexpected advantages and utilities. The structure and co-operation of structure of the on-board temperature/humidity sensor will become apparent when read in conjunction with the following description, drawing figures, and appended claims.

The foregoing has outlined broadly the more important features of the invention to better understand the detailed description that follows, and to better understand the contributions to the art. The on-board temperature/humidity sensor system is not limited in application to the details of construction, and to the arrangements of the components, provided in the following description or drawing figures, but is capable of other embodiments, and of being practiced and carried out in various ways. The phraseology and terminology employed in this disclosure are for purpose of description, and therefore should not be regarded as limiting. As those skilled in the art will appreciate, the conception on which this disclosure is based readily may be used as a basis for designing other structures, methods, and systems. The claims, therefore, include equivalent constructions.

Further, the abstract associated with this disclosure is intended neither to define the on-board temperature/humidity sensor, which is measured by the claims, nor intended to limit the scope of the claims. The novel features of the on-board temperature/humidity sensor are best understood from the accompanying drawing, considered in connection with the accompanying description of the drawing, in which similar reference characters refer to similar parts, and in which:

### BRIEF DESCRIPTION OF THE DRAWINGS

FIG. 1 of the drawing is an exploded perspective view of the on-board temperature/humidity sensor system; and;

FIG. 2 is a block diagram showing the operative interconnection of the on-board temperature/humidity sensor system with at least one remote data collector.

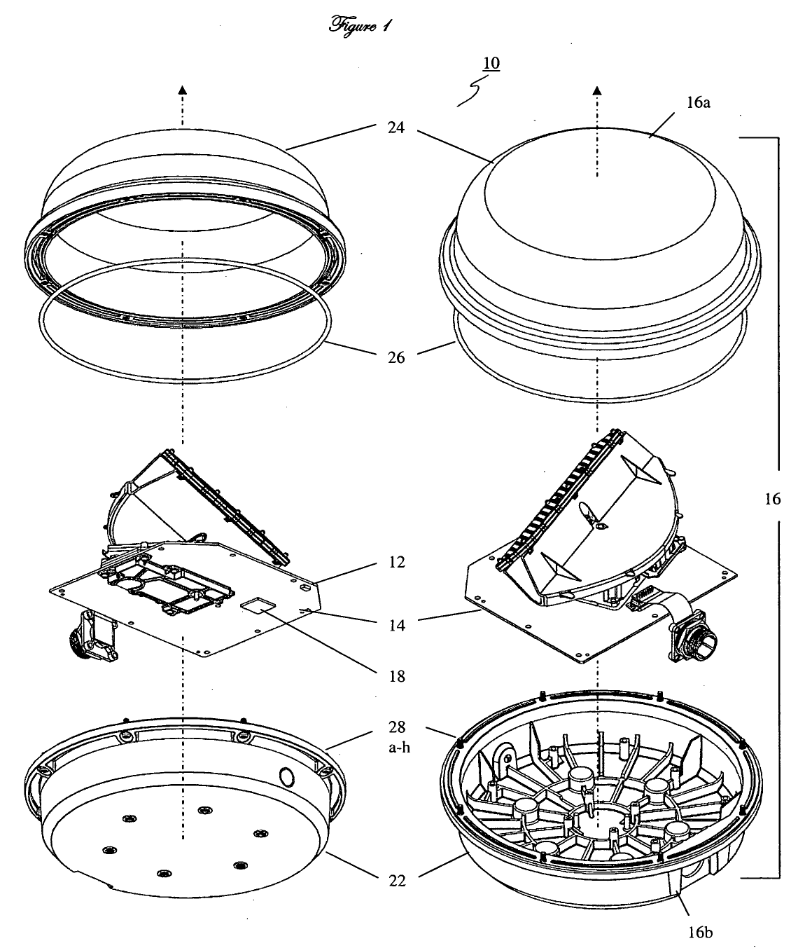

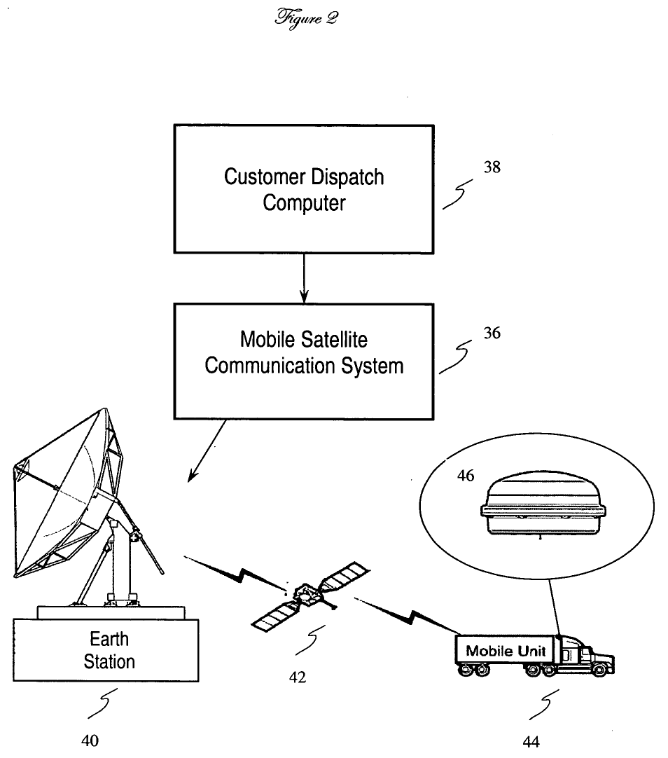

Regarding FIGS. 1-2, to the extent that subscripts to the numerical designations include the lower case letter “n,” as in “a-n,” the letter “n” is intended to express a number of repetitions of the element designated by that numerical reference and subscripts.

### DETAILED DESCRIPTION

As shown in FIGS. 1-2, an on-board temperature/humidity sensor system 10 is provided that in its broadest context includes a sensor 12 mounted on a circuit board 14 in a vehicle-mounted enclosure 16. The sensor 12 is capable of monitoring desired minimum and maximum ranges of the environmental properties within the enclosure 16. The environmental properties within the enclosure 16 that may be measured by sensor 12 include at least temperature and relative humidity. Sensor 12 also is operatively connected to a microprocessor with programmable sensor data acquisition capabilities 18 shown diagrammatically in FIG. 1. The microprocessor with programmable sensor data acquisition capabilities 18 is adapted to collect data about environmental properties within enclosure 16 when enclosure 16 is closed in an operative environment, and to transmit the data to a remote data collector 20 shown in FIG. 2.

More specifically, an on-board temperature/humidity sensor system 10 includes an enclosure 16. As shown, enclosure 16 includes a base unit 22 connectable to a cover 24. Base unit 22 is connectable to a cover 24 using at least one seal 26, as well as connectors 28a-h shown diagrammatically in FIG. 1.

In an operative environment, circuit board 14 is located within enclosure 16. In a non-exclusive embodiment shown in FIG. 1, circuit board 14 is a printed circuit board containing a wide range of electronics. As shown in FIG. 1, sensor 12 is mounted on circuit board 14 by soldering during manufacture of circuit board 14.

Sensor 12 is capable of monitoring at least temperature and relative humidity within enclosure 16 when enclosure 16. Non-exclusive examples of sensor 12 are manufactured by Sensirion AG of Switzerland as either model SHT10, SHT11, or model SHT15, both of which are surface-mountable leadless chip carrier, as shown at www.sensirion.com. Sensor 12 is preferably a single chip sensor with high reliability and long term stability, provide superior signal quality with low power consumption, fast response time, and insensitivity to external disturbances.

To place the on-board temperature/humidity sensor system 10 in an operational context and environment, FIG. 2 is a block illustration of a mobile satellite communications system 30. As shown, FIG. 2 includes at least one customer dispatch computer 32, a variety of hardware and software components operatively connected to (i) the customer dispatch computer 32, an earth station 34, a satellite 36, and to a vehicle 38. Mobile satellite communications system 30 is designed to enable users of the system to communicate with vehicles, determine vehicle location, track vehicles, and allow a variety of communications among a dispatcher, an operator and passenger of a vehicle, and even authorized third parties otherwise outside the system, among other achievements.

As also shown diagrammatically in FIG. 2, vehicle 38 is equipped with a satellite data modem 40 that is part of the mobile satellite communications system 30. Satellite data modem 40 is capable of transmitting and receiving data across mobile satellite communications system 30. Enclosure 16 is a component of satellite data modem 40. Environmental conditions within the enclosure 16 may affect the quality and quantity of messages and data transmitted and received across mobile satellite communications system 30.

As also shown diagrammatically in FIG. 2, vehicle 38 is equipped with a satellite data modem 40 that is part of the mobile satellite communications system 30. Satellite data modem 40 is capable of transmitting and receiving data across mobile satellite communications system 30. Enclosure 16 is a component of satellite data modem 40. Environmental conditions within the enclosure 16 may affect the quality and quantity of messages and data transmitted and received across mobile satellite communications system 30.

Accordingly, as also shown diagrammatically in FIG. 2, on-board temperature/humidity sensor system 10 includes the microprocessor with programmable sensor data acquisition capabilities 18. Sensor output from sensor 12 may be polled and relayed as part of the remote monitoring capabilities of both the microprocessor with programmable sensor data acquisition capabilities 18 and mobile satellite communications system 30.

The on-board temperature/humidity sensor system 10 shown in drawing FIGS. 1-2 includes at least one embodiment not intended to be exclusive, but merely illustrative of the disclosed but non-exclusive embodiments. Claim elements and steps in this document have been numbered and/or lettered solely as an aid in readability and understanding. Claim elements and steps have been numbered solely as an aid in readability and understanding. The numbering is not intended to, and should not be considered as intending to, indicate the ordering of elements and steps in the claims. Means-plus-function clauses in the claims are intended to cover the structures described as performing the recited function that include not only structural equivalents, but also equivalent structures.

1. A system for monitoring temperature and humidity, comprising:
an enclosure adapted to contain a printed circuit board;
a sensor mounted on the surface of the printed circuit board adapted to monitor temperature and humidity within the enclosure; and
a microprocessor with programmable sensor data acquisition capabilities operatively connected to the sensor adapted to selectively establish monitored threshold limits of temperature and humidity ranges within the enclosure and to transmit temperature and humidity data collected from the sensor to a at least one remote data collector.

2. A system for monitoring temperature and humidity as recited in claim 1, wherein the sensor further monitors functionality of a modem operatively connected to the enclosure.

3. A system for monitoring temperature and humidity as recited in claim 2, wherein the sensor is mounted on a surface of the printed circuit board by soldering during manufacture of the printed circuit board.

4. A system for monitoring temperature and humidity as recited in claim 2, wherein the sensor is removably mountable on the surface of the printed circuit board.

5. A system for monitoring temperature and humidity as recited in claim 1, wherein the enclosure is mountable on a vehicle.

6. A system for monitoring temperature and humidity as recited in claim 1, wherein the microprocessor with programmable sensor data acquisition capabilities is operatively connected to one or more servers located remote from the enclosure.

7. In a vehicle-mounted enclosure, a sensing device, comprising:
a sensor,
wherein the sensor is mounted on an electronic circuit board for monitoring environmental properties within the enclosure;
means operatively connected to the sensor for selecting desired minimum and maximum ranges of the environmental properties within the enclosure; and
means operatively connected to the sensor for collecting data relating to the desired minimum and maximum ranges of the environmental properties within the enclosure; and
means operatively connected to the sensor for transmitting the data to a remote data collector.

8. In a vehicle-mounted enclosure, a sensing device as recited in claim 7, wherein the sensor is capable of monitoring temperature within the enclosure.

9. In a vehicle-mounted enclosure, a sensing device as recited in claim 7, wherein the sensor is capable of monitoring humidity within the enclosure.

10. In a vehicle-mounted enclosure, a sensing device as recited in claim 7, wherein the means operatively connected to the sensor for selecting desired minimum and maximum ranges of the environmental properties within the enclosure includes a microprocessor with programmable sensor data acquisition capabilities.

11. In a vehicle-mounted enclosure, a sensing device as recited in claim 10, wherein the microprocessor with programmable sensor data acquisition capabilities is capable of transmitting environmental data to at least one remote modem.

12. In a vehicle-mounted enclosure, a sensing device as recited in claim 7, wherein the means operatively connected to the sensor for collecting data relating to the desired minimum and maximum ranges of the environmental properties within the enclosure includes a microprocessor with programmable sensor data acquisition capabilities.

13. In vehicle-mounted enclosure, a sensing device as recited in claim 12, wherein the microprocessor with programmable sensor data acquisition capabilities is capable of transmitting environmental data to a plurality of remote data collectors.

14. A method for sensing temperature and humidity within a remote vehicle-mounted enclosure, comprising the steps of:
selecting material to form the enclosure;
manufacturing the enclosure;
installing within the enclosure a circuit board;
mounting on the circuit board a sensor adapted to monitor conditions within the enclosure; and
including a microprocessor with programmable sensor data acquisition capabilities in the enclosure for collecting and transmitting information about temperature and humidity within the enclosure to at least one server not located in the enclosure.

15. A method for sensing temperature and humidity within a remote vehicle-mounted enclosure, wherein the mounting step includes the substep of soldering the sensor on the circuit board.

16. A method for sensing temperature and humidity within a remote vehicle-mounted enclosure, wherein the mounting step includes the substep of soldering the sensor on a surface of the circuit board.
